(19) United States
(12) Patent Application Publication
(10) Pub. No.: US 2013/0304538 A1
(43) Pub. Date: Nov. 14, 2013

(54) CONSUMER FEEDBACK COLLECTION SYSTEM

(71) Applicants: Ron ARAD, Bronx, NY (US); John Arthur GOODMAN, Bethesda, MD (US)

(72) Inventors: Ron ARAD, Bronx, NY (US); John Arthur GOODMAN, Bethesda, MD (US)

(73) Assignee: 45Sec.com LLC, Fort Lee, NJ (US)

(21) Appl. No.: 13/889,051

(22) Filed: May 7, 2013

Related U.S. Application Data
(60) Provisional application No. 61/644,112, filed on May 8, 2012.

(51) Int. Cl. G06Q 30/02

(52) U.S. Cl. CPC G06Q 30/0201
USPC 705/7.29

(57) ABSTRACT

The systems, methods and apparatuses described herein provide for consumer feedback input and retention management, allowing feedback providers to provide inputs using electronic devices. According to the present disclosure, feedback providers are able to provide feedback to a wide variety of feedback recipients, and an application running on the user's device may automatically locate and deliver these inputs via the correct communications channel associated with a specific feedback recipient location. Feedback recipients may be able to manage the inputs, listen, read voice to text translation, and respond to inputs with emails and/or coupons. Feedback recipients may be able to use the given inputs to feed positive and negative comments back to employees, add comments, set priorities for internal uses, and extract transcripts to combine with existing analyses of customer complaints and service measurements. The systems, methods and apparatuses described herein may also allow customers to provide feedback on specific products by requesting a product identifier and assisting customers in locating product production codes.

### FIELD OF THE DISCLOSURE

The systems, methods and apparatuses described herein relate to the general field of customer service and provide for the improved provision and receipt of positive and negative feedback between a consumer and a provider.

### BACKGROUND

Customer feedback is valuable information for service and product providers, governmental and non-profit organizations, and other types of businesses. However, research conducted for the White House Office of Consumer Affairs from 1978-1986, based on a cross-sectional survey of the US population, confirms that most consumers choose not to provide feedback for a variety of reasons. “Consumer Complaint Handling in America: An update Study,” provided under U.S. Government Contract No. HHS-100-84-0065.

Furthermore, what limited feedback is provided is often difficult to analyze and may not provide simple methods by which the provider can respond to the consumer. It is well-known that current complaint and feedback mechanisms present a number of barriers to easy communication between consumers and providers. Strategic Customer Service, ISBN-13:978-0-8144-1333-3, AMACOM, American Management Association (NY, N.Y. 2009).

From the perspective of the consumer, these barriers include:
1. The effort required to find the communication channel;
2. A fear of confrontation with an employee or manager if feedback is given in person;
3. The time required to provide feedback and the expectation that the communication channel will have a time-wasting queue or will be closed; and
4. A belief that even if the communication is made that the feedback recipient will not be responsive or not care.

From the perspective of the provider, these barriers include:
1. The expense of running a communication channel, providing quality customer service, and providing broad hours when organizations and individuals are using the product or service, especially for smaller feedback recipients;
2. The vagueness of consumer feedback;
3. The complexity of the organization effectively responding to the individual's feedback;
4. The level of detail that information that must be collected to ensure proper routing to the responsive party of the feedback recipient; and
5. That the structure of most customer surveys focus on the negative and burden the feedback provider when the majority of feedback provider experiences are positive; this results in very few positive surveys being submitted, depriving feedback recipients of feedback that could be used for encouraging and recognizing high performing employees. Positive feedback is a huge motivator that is, in some cases, worth more to employees than salary increases.

Additionally, one of the crucial data points needed by a business when providing support for a product is the product production identifier. Depending on the product, this identifier is known as the serial number or production code. Without this number, businesses cannot track a pattern of problems and link the specific product problem with any known problems or to identify trends or do the necessary research to identify the root cause of the problem. Thus, when a customer attempts to provide feedback by, e.g., engaging product support, a considerable amount of time is spent on having the customer find the location of the identifier and provide this identifying information.

Two common methods of acquiring consumer feedback are the use of customer surveys and the use of 1-800 numbers. However, both methods do little to mitigate common barriers to useful feedback. Surveys often receive very few responses, and in some cases the responses received are incomplete. 1-800 numbers require the consumer to copy down a phone number and then, often, will require the consumer to wait in a long phone queue.

One company that has attempted to break down these barriers is Chick-Fil-A, which has posted the cell phone number of owner/operators on signs in some stores. This eliminates some of the barriers but still requires the consumer to copy down the number or actually submit the complaint while he remains in the store, which could result in a confrontation with a store employee or owner/operator.

### SUMMARY

The systems, methods and apparatuses described herein provide for consumer feedback, input and customer retention management, allowing feedback providers (consumers and customers) to effortlessly provide inputs using electronic devices, such as mobile devices. According to the present disclosure, feedback providers are able to provide feedback to a wide variety of feedback recipients, and an application running on the user's device may automatically locate and deliver these inputs via the correct communications channel associated with a specific feedback recipient location. Feedback recipients such as businesses owners will be able to manage the inputs, listen, read voice to text translation, and respond to inputs with emails and/or coupons. Feedback recipients such as businesses/owners may be able to use the inputs to transmit positive and negative comments back to employees, add comments, set priorities for internal uses, and extract transcripts to combine with existing analyses of customer complaints and service measurements.

### BRIEF DESCRIPTION OF THE DRAWINGS

FIG. 1 is a block diagram of an exemplary system according to the present disclosure.

FIGS. 2-8 illustrate exemplary methods for providing, receiving and processing feedback according to the present disclosure.

### DETAILED DESCRIPTION

Certain illustrative aspects of the systems, apparatuses, and methods according to the present disclosure are described herein in connection with the following description and the accompanying figures. These aspects are indicative, however, of but a few of the various ways in which the principles of the disclosure may be employed and the present disclosure is intended to include all such aspects and their equivalents. Other advantages and novel features of the disclosure may become apparent from the following detailed description when considered in conjunction with the figures.

In the following detailed description, numerous specific details are set forth in order to provide a thorough understanding of the disclosure. In other instances, well known structures, interfaces, and processes have not been shown in detail in order not to unnecessarily obscure the disclosure. However, it will be apparent to one of ordinary skill in the art that those specific details disclosed herein need not be used to practice the disclosure and do not represent a limitation on the scope of the disclosure, except as recited in the claims. It is intended that no part of this specification be construed to effect a disavowal of any part of the full scope of the disclosure. Although certain embodiments of the present disclosure are described, these embodiments likewise are not intended to limit the full scope of the disclosure.

The present disclosure comprises systems, methods and apparatuses for the solicitation of feedback (e.g., complaints, suggestions, compliments etc.) from a feedback provider (e.g., a consumer, employee, manager, etc.) to a feedback recipient (e.g., a service or product provider, governmental or non-profit organization, sole proprietorship, partnership, etc.). Exemplary feedback recipients may include home service or repair technicians, private tutors, doctors, teachers, and gym instructors.

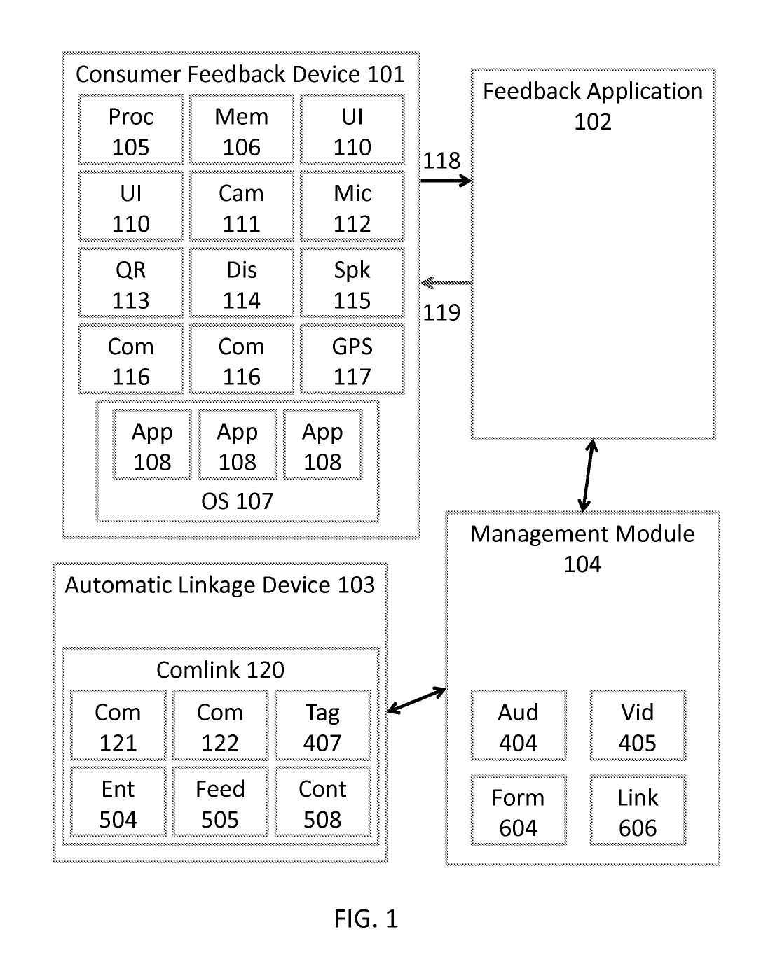

FIG. 1 illustrates an exemplary system according to the present disclosure. As shown on FIG. 1, a system according to the present disclosure may comprise one or more consumer feedback devices 101. A consumer feedback device 101 may provide an easy-to-use channel for a consumer to provide feedback. In another aspect, the consumer feedback device 101 also may permit the feedback recipient to display a response received from the feedback recipient.

In certain embodiments, a suitable consumer feedback device 101 may be a mobile electronic device, such as a mobile phone or smart phone, a personal digital assistant (PDA), a laptop computer, a tablet, or any other device capable of storing and transmitting feedback. A consumer feedback device 101 may comprise, for example, at least one processor 105 and at least one memory 106, configured to run an operating system and one or more applications.

The consumer feedback device 101 may further comprise one or more user input interfaces 110 by which it may capture and input user feedback. A user input interface may comprise one or more buttons, a keyboard (which may be a physical keyboard or a virtual keyboard implemented through a touch sensitive display), a camera 111 for capturing video or still images, a microphone 112 capable of recording audio feedback (e.g., voice). The user interface may further comprise a QR reader 113, capable of capturing QR codes.

The consumer feedback device 101 may further comprise a display device 114 for reviewing and viewing feedback input. In an aspect, the consumer feedback device 101 may comprise a speaker 115 or similar output function to provide for reviewing audio feedback.

The consumer feedback device 101 may further comprise one or more communications ports 116, by which it may transmit and receive media content, identifying information, digital data, and other information. The one or more communication ports may be comprised of any combination of hardware and/or software appropriate for establishing and maintaining two-way communications, including, but not limited to, wired protocols such as serial, parallel, Ethernet, and USB, and wireless protocols such as Bluetooth, near field communications, infrared, various flavors of IEEE 802.11, and/or custom connectors/protocols. The device 101 may further comprise a GPS transceiver 117.

It is to be understood that these components are illustrative and need not necessarily be included in every embodiment of a consumer feedback device 101.

The consumer feedback device 101 may be configured to run a feedback application 102 according to the present disclosure. The feedback application 102, as is described in further detail below, may receive feedback input 118 from a consumer via the device 101 and create a feedback message 119.

As shown on FIG. 1, a system according to the present disclosure may further comprise an automatic linkage device 103. The automatic linkage device 103 may comprise a server with remote and local communication capabilities running an automatic linkage application. The automatic linkage device 103 may be configured to access databases to correlate the feedback received from the feedback application 102 with a feedback recipient. In an aspect, the automatic linkage device 103 may be configured to obtain information on the consumer's location or product identification and look up contact information for the feedback recipient from a local system using a local communication capability. In another aspect, the automatic linkage device 103 may be configured to create a new entity and store the feedback. The automatic linkage device 103 may further be configured to extract data from an external database using a remote communication capability (e.g., through Google, Yellowpages or any other public database). In another aspect, the contact information may be manually added to the automatic linkage device 103. The automatic linkage device 103 may be configured to extract provide the contact information to the management module 104 via a remote or internal communication capability. In an aspect, the automatic linkage application may be configured to exchange information to the feedback application 102 and from the feedback application 102. In an aspect, the automatic linkage application may be configured to exchange information to the management module 104 and from the management module 104 using remote or internal communication capabilities.

Once the feedback application 102 (running on a feedback device 101) has created a feedback message, an automatic linkage device 103 may automatically find contact information or any suitable form of communications link 120 (e.g., email address, phone number, mailing address, web site, drop box, bulletin board, call center, social media service, etc.). In order to do so, the automatic linkage device 103 may integrate multiple data sources to identify the appropriate communications link to assure feedback delivery.

Also as shown on FIG. 1, an exemplary system according to the present disclosure may comprise a management module 104 configured to automatically deliver feedback messages to a feedback recipient. A management module 104 may comprise a server configured to run a management application. In an aspect, the remote server may comprise remote and local communication capabilities. In an aspect, the server may comprise a processor and memory configured to run the management module 104 and the automatic linkage application. In an aspect, the management module application and automatic linkage application may share remote and local communication capabilities and be able to share access to local database resources. In an aspect, the management module application may be configured to exchange information to the feedback application 102 and from the feedback application 102. In an aspect, the management module 104 may be configured to exchange information to the automatic linkage application and from the automatic linkage application using remote or internal communication capabilities. As will be described in greater detail below, the linkage device 103 and the management module 104, working together, may operate to deliver feedback messages even when the feedback recipient has not provided a solicitation message or publicized the availability of a communications link. In certain embodiments, the management module 104 may enable the business owner to transmit feedback to employees to enhance motivation.

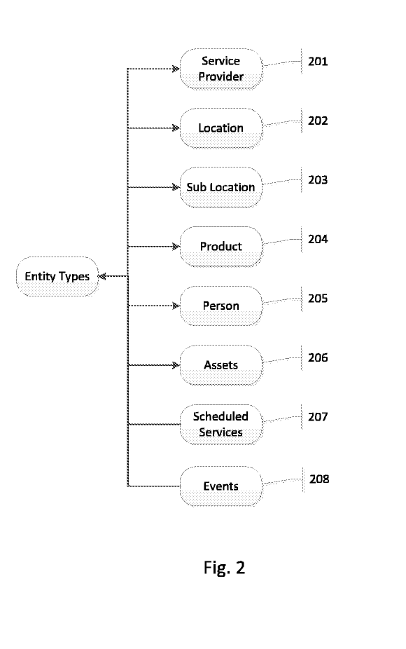

FIGS. 2-7 illustrate exemplary methods for providing, receiving and processing feedback according to the present disclosure.

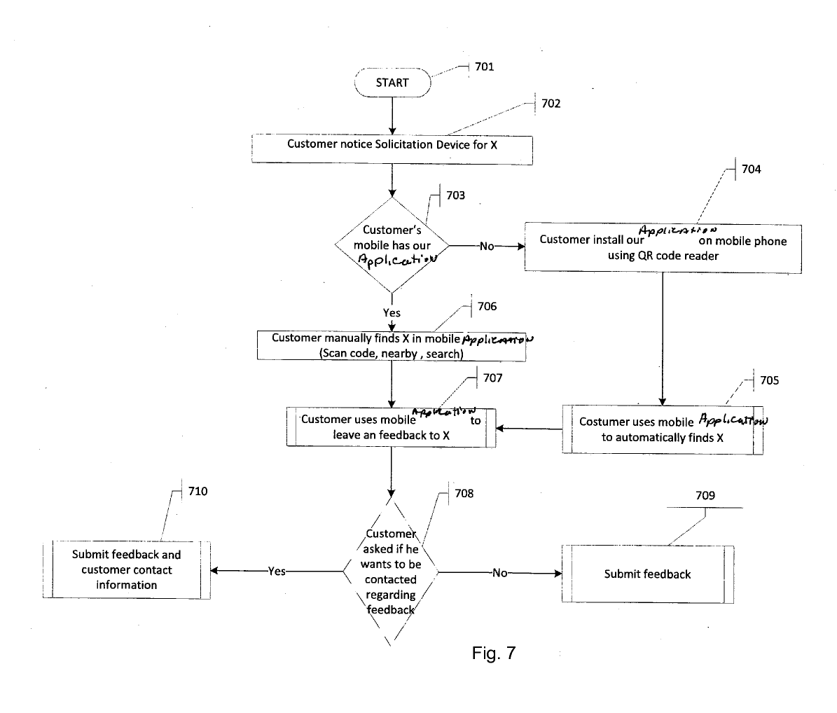

As shown on FIG. 7, the feedback device 101 may be configured to run the feedback application 102 for the purpose of receiving consumer feedback. The feedback application may run upon activation by a single touch to a feedback button located on the feedback device 101. In other embodiments, as described in further detail below, the feedback device 101 may be configured to run the feedback application 102 when the consumer enters an area, such as a restaurant, designated to receive feedback. The feedback device 101 then may be prompted to indicate to the consumer that the recipient would like feedback. This may occur, for example, by a pop-up message or display appearing on the feedback device 100. In certain embodiments, feedback application 102 may request the feedback provider to provide both positive and negative feedback. In one aspect of the present disclosure, the consumer feedback device 101 may contain a Quick Response (QR) code and a solicitation message. This aspect of the feedback device might include, for example, a sign or table tent card with a solicitation message that breaks down the barrier of consumer belief that the business owner does not care and then provides the effortless channel of the QR code to submit the feedback.

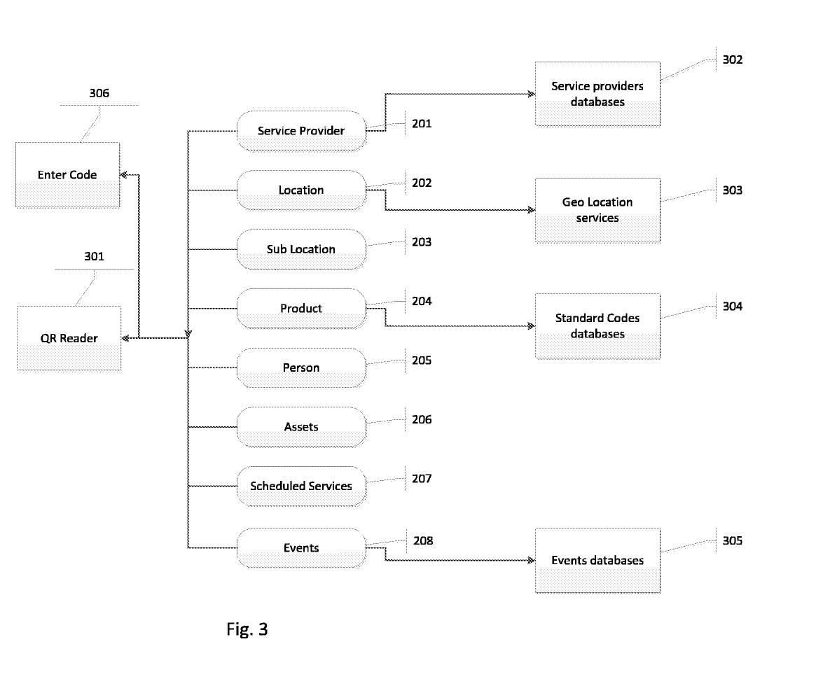

With reference to FIGS. 2 and 3, a wide variety of information is available to allow the consumer to select the appropriate feedback recipient, depending upon whether the intended feedback recipient has previously elected to participate in solicitations in accordance with the present disclosure. If the business is participating, the feedback application 102 may automatically select the business. For example, as described in greater detail below, in situations in which a recipient is participating and has registered with the system a QR code, a text code, or both may be used to identify the recipient.

In other situations, the feedback recipient may not have registered to receive feedback or otherwise may not be immediately “selectable” via the application 102. In such cases, a variety of information known about the intended feedback recipient can be used to identify it for the purposes of the application 102. For example, the feedback application 102 may use location information 202 to identify the appropriate feedback recipient. Exemplary locations may include stores, hotels, apartments, hospitals, and department stores. In another aspect, the information may comprise a sub-location 203. In an aspect of the present disclosure a sub-location may include, as non-limiting examples, a room in a hotel, a department within a store, an exhibit hall within a museum. Sub-locations according to the present disclosure may provide tunable granularity (e.g., provide feedback for different levels or subdivisions of business owner offerings, e.g., different locations of restaurants, departments within a store or specific bathrooms within a museum) to any business. In another aspect of the present disclosure, the information may be a product 204. In some aspects of the disclosure, the product 204 may be a medication, food product, clothing, a book, or sports equipment. The product 204 may comprise and include warning information, pricing information, counter-indications, storage and preparation instructions, sources and alternatives. In another embodiment of the present disclosure, the information may be a person 205. In an aspect of the present disclosure, the person 205 may be a politician, a judge, a candidate, or a celebrity. In other aspects of the disclosure, the information may be a rental 206. In an aspect, the rental 206 may be a rental of a durable good, for example, a rental car, a truck, heavy equipment, a boat, a tool, or sporting equipment. In yet another aspect, the information may be related to a scheduled service 207. Scheduled services according to the present disclosure may comprise, as non-limiting examples only, flights, bus rides, subway rides and train rides. In another aspect of the present disclosure, the information may be about an event 208. Events according to the present disclosure, by way of non-limiting example, include sport events, concerts, kids' shows, and conferences.

As shown in FIG. 3, this information may be combined with information in publicly-available databases for greater recipient identification capability. For example, the business might be identifiable based on its geo-location. In an aspect of the present disclosure, the geo-location may obtained from a GPS transceiver within the consumer feedback device 101. The geo-location may be used to query a geo-location service 303 by a communications port connected to the internet. In an aspect of the present disclosure, locations may be found using the mobile devices location by searching in geo-location databases such as Google Places, Foursquare, Yellow Pages and factual.com. In another aspect of the present disclosure, the consumer feedback device 101 may obtain information using a standard codes database 304. In an aspect, the product 204 may be located by scanning standard codes such as UPC, ISBN, and EAN and locating the contact information in a standard code database. In a further aspect of the present disclosure, consumer feedback device 101 may comprise functions to search an event database 305. In an aspect of the present disclosure, an event 208 may be located by searching an event database 305. An exemplary, non-limiting example of an event database 305 may comprise Ticketmaster.

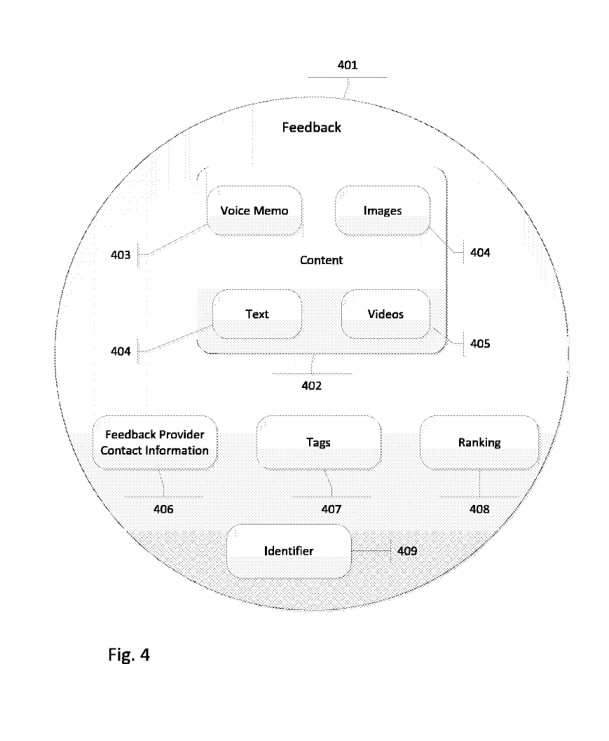

FIG. 4 shows a diagram of an exemplary mechanism for using the feedback device 101 and the feedback application 102 to collect feedback and to create a feedback message according to the present disclosure. A feedback input 401 according to the present disclosure may comprise different kinds of content 402. In one aspect, the feedback provider may record oral feedback, such as a voice memo 403, via a microphone. In another aspect, the feedback provider may type text 404 by either a physical or virtual keyboard. The feedback provider may review recorded feedback either through a visual display device or through a speaker and the feedback provider may re-record or revise the input if desired or dispatch the feedback to the feedback recipient. A feedback provider may also attach a photo 404 or a video 405 taken with the consumer feedback device 101. For example, a photo might be used to in a restaurant context to report problems such as a very small portion size, raw chicken, or overcooked hamburger. In a further aspect of the present disclosure, the input 401 may be linked to a ranking 408. In an aspect, the ranking 408 may be determined by the time of receipt of input 401. In another aspect, ranking 408 may comprise a ranking based on a selection of the feedback provider. In another aspect, ranking 408 may comprise a ranking assigned by the feedback recipient. In a further aspect, the ranking 408 may be provided by other feedback providers by selection or vote. In an aspect, ranking 408 may be fixed or may be dynamic.

Additionally, in certain embodiments, the feedback application 102 also may incorporate the consumer's contact information into the feedback input, if the consumer desires or is willing to give permission to be contacted 406 by the feedback recipient. This information may be used according to the present disclosure by the management system to facilitate two-way communication.

A final component of the feedback input may be a product or service identifier 409. In an aspect, the identifier may be based, for example, on the code of the feedback device 101, a product bar code, a location code, etc., which might be used to research the feedback recipient contact information.

It will be understood that a consumer may use the feedback device 101 and the feedback application 102 to enter all of this information while at the service provider's location (e.g., a restaurant) without directly engaging any employees or other personnel. This will allow the user to provide instant feedback with very little effort, while the experience is still fresh in his or her mind, without risking confrontation.

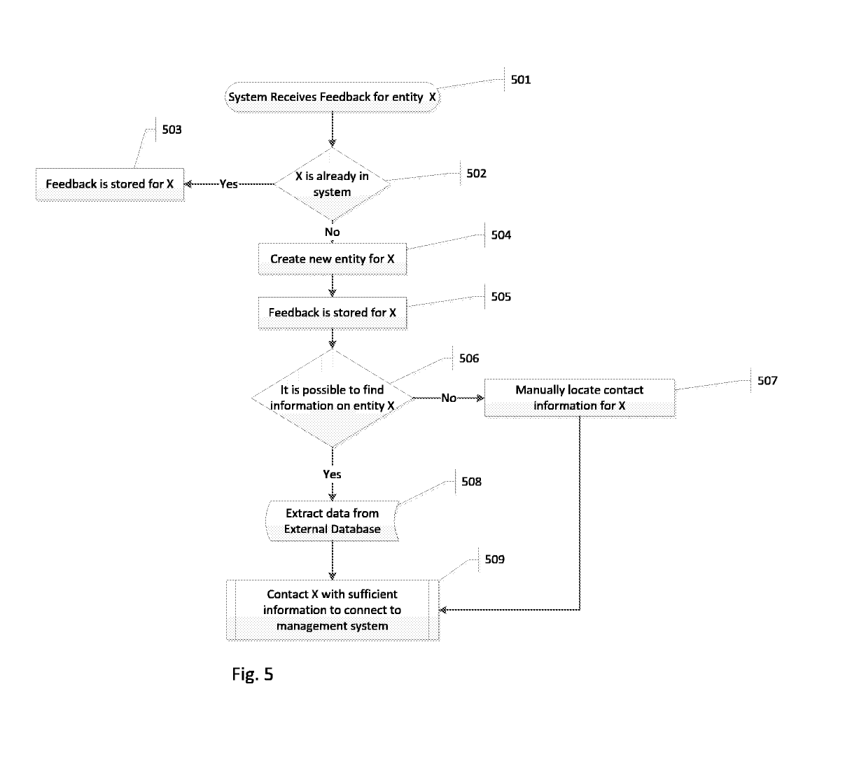

FIG. 5 illustrates an exemplary method by which a communications link may be set up between the identified feedback recipient (identified, e.g., in accordance with the methods described with respect to FIGS. 2 and 3) and the consumer for the purpose of transmitting the feedback entered into the feedback device 101 (e.g., in accordance with the method described with respect to FIG. 4). The linkage device 103 may be configured to provide any necessary communications information to the feedback device 101 for the purpose of receiving a feedback message. If the feedback recipient is already in the system 503, the linkage device 103 may automatically correlate and associate the feedback input with the existing feedback recipient 503.

In another aspect, if a feedback recipient has not previously elected to participate in the system, the linkage device 103 may automatically find contact information from an external database. Contact information for an unregistered feedback recipient may be obtained in a variety of ways. In one aspect according to the present disclosure, communications information for a feedback recipient may be obtained from publicly-available information. For example, public databases may contain this information, such as Angie's list, service magic, and Craigslist. Then, the linkage device 103 may create a new entity 504 and automatically store the contact information and the feedback 505.

In certain embodiments, the linkage device 103 may assign a label or tag 407 to the feedback for the purpose of feedback analysis or response. In one aspect, the tag 407 may comprise one or more input codes based on input codes on the consumer feedback device 101. In another aspect, the tag 407 may comprise one or more input codes defined by the management module 104. In yet another aspect the tag 407 may be defined by search or location data associated with the feedback recipient.

As noted previously, in certain embodiments, the consumer may have provided his or her contact information along with his or her feedback. In such embodiments, the feedback content 402 may be linked via the linkage device 103 to feedback provider contact information 406. Also as noted previously, in another aspect, the content 402 may be linked via a linkage device (FIG. 5) to a product or service identifier 409. This identifier 409 may be a unique identifier, and in certain embodiments may be dynamically assigned.

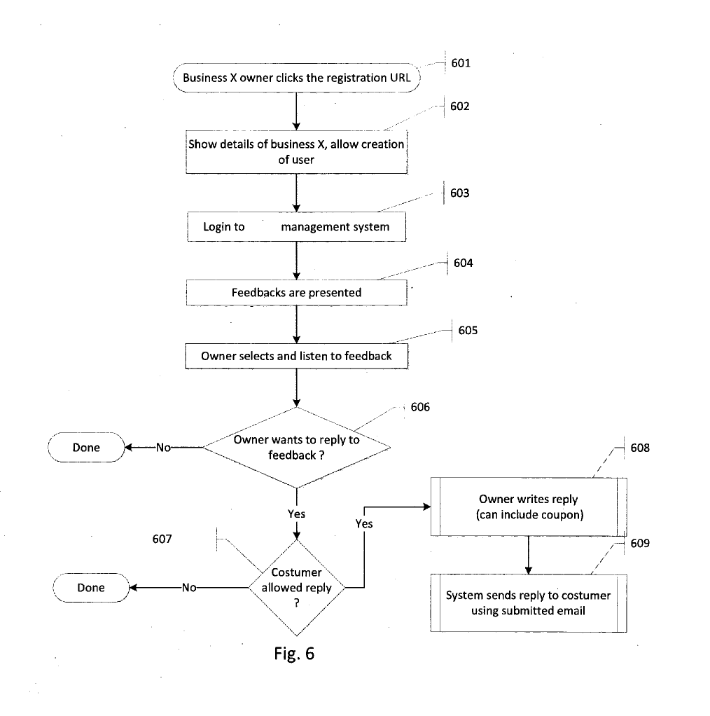

FIG. 6 shows an exemplary method by which feedback may be received from a consumer, via the feedback device 101, application 102 and linkage device 103, and distributed to a feedback recipient via the management module 104. A management module 104 according to the present disclosure may be able to perform some or all of the following four tasks: (1) Receive consumer feedback from a feedback device 101 via the linkage device 103, and format a feedback message to the feedback recipient with appropriate consumer contact information (604); (2) Provide any information about the feedback recipient to the linkage device 103 in order to locate the feedback recipient contact information (508); (3) Manage any contact to the feedback recipient based on the information from the linkage device (606); and (4) Manage the aggregate reporting of feedback messages to the feedback recipient. For example, in one embodiment, the management software may take the contact data from the linkage device and transmit the offer of consumer feedback. In another embodiment according to the present disclosure, the management software may transmit an audio file 403 of any verbal dictations provided by the consumer as well as any appended images 404 or videos 405.

In embodiments in which the consumer has provided his contact information, the management module 104 also may receive and process the consumer's contact information, and may manage any response from the feedback recipient to the consumer. In an aspect according to the present disclosure, the feedback recipient may be able to send an email and, if desired, allow the feedback provider to print out a coupon or refund voucher 608.

The management module 104 may then correlate the feedback recipient identifier information with existing feedback recipients. In another aspect, the management module 104 may create and store information relating to new feedback recipients.

According to the present disclosure, the management module 104 may provide the information received by the feedback application 102 (e.g., location information and product or feedback device code), combined with the application subscriber's information to the linkage device 103, to support location of the feedback recipient and its sub-unit or product if multiple locations or products are involved.

In an aspect according to the present disclosure, the management module 104 may produce tabulations of feedback and where appropriate, classify feedback tabulations by whether positive or negative product, staff member and location codes. The feedback recipient may use this information to provide both positive and negative feedback to its staff.

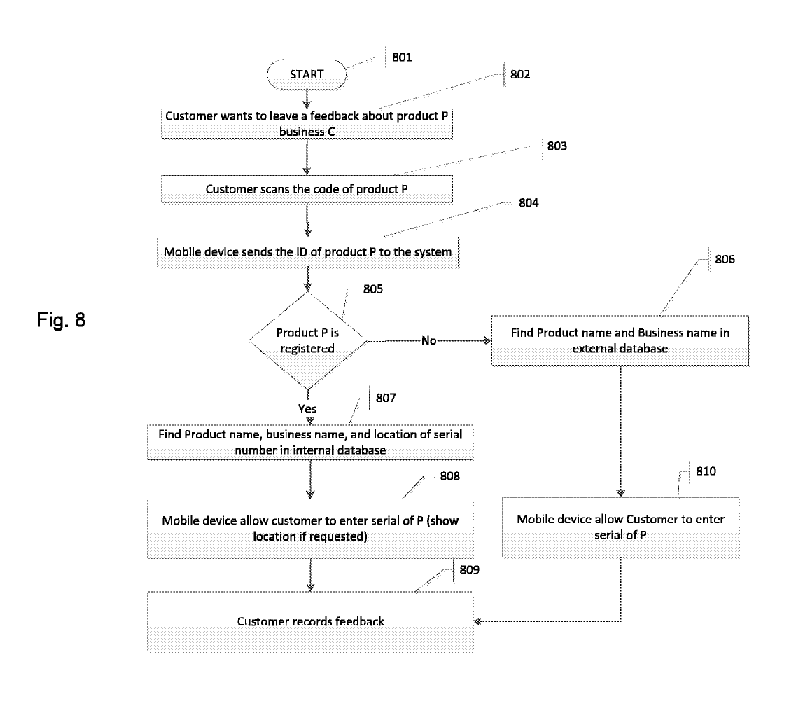

As shown in FIG. 8, certain embodiments may allow a customer to scan a product code of a product for which he desires to give feedback. This may allow customers to easily find and provide product identifiers such as production codes or serial numbers that are critical to the actionability of the feedback to the business owner quality function. Feedback recipients may save valuable time and efforts otherwise required to explain to consumers how to locate the same identifier.

In order to do so, the customer may use his feedback device 101 to scan a product code (UPC, ISBN, or EIN) found on the product (803). The feedback device 101 may use any appropriate translation technique to convert the scanned code into the product type identifier. The feedback device may transmit the product type into the system (804).

If the product was previously registered in the system, the system may send back the product name, the name of the business making the product, and instructions on how to find the product identifier (807). In certain embodiments, the feedback device 101 may be configured to receive the identifier (808) from the consumer, and may be able to assist the consumer to locate the identifier on the product. After the client provides the code, he can continue regularly to record and submit his feedback (809).

If the product was not previously registered with a system according to the present disclosure, the system may extract the product type name, and the name of the business making the product from one or more external databases (806). The customer may then enter the product identifier, but help in locating the product may not be available (810). As a final step the customer can record and send his feedback for the product.

### EXAMPLES

In some aspects, exemplary implementations of the application may facilitate transmission of the feedback information in each of four possible situations:
A. Consumer or feedback provider has the application and is in a participating feedback recipient or encountering a participating product or service.
B. Consumer or feedback provider does not have the application and is in a participating feedback recipient or encountering a participating product or service.
C. Consumer or feedback provider has the application and is in a non-participating feedback recipient or encountering a non-participating product or service.
D. Consumer or feedback provider does not have the application and is in a non-participating feedback recipient or encountering a non-participating product or service.

In situation A, the consumer or feedback provider has previously used a mobile device and the application is present on the consumer feedback device 101. In an aspect of the present disclosure, the feedback provider may use the application to find a service provider 201. In another aspect, the feedback provider may use the application to find a specific business location 202. In another aspect according the present disclosure, the feedback provider may identify feedback recipient information to give feedback on a product 204 or airline flight 207 or rental car location 202 described in FIG. 2. The Application provides several methods for identifying the business including but not limited to, for example, service provider database 302 or geo-location service 303, depending upon whether the feedback recipient is a participating feedback recipient using a feedback device or is not a participating feedback recipient. If they are a participating feedback recipient, the feedback device may have a code 306 and also the geo-locator 303 may identify the feedback recipient as participating based on its geo-location.

In situation B the feedback provider does not have the mobile device application but is in a participating feedback recipient location with a consumer feedback device 101. In an aspect of the present disclosure, the feedback provider may use the QR code 301 found in the feedback device solicitation message to download and install it. In one aspect 705, the feedback provider may use the mobile device application for the first time and may be presented with the option to leave an input to the feedback recipient for which he scanned the QR code. In another aspect 707, the feedback provider may use the mobile device application to provide his input (FIG. 4). In aspect 708 according to the present disclosure, after providing input the feedback provider may allow the feedback recipient to reply 607 and to contact him regarding the input. When allowed, in aspect 710, the feedback recipient's contact information may be provided along with the input 707. If not, 709, his contact information may not be provided.

In situation C, the feedback provider has the application and the feedback recipient may not be a participating feedback recipient, the application may locate the feedback recipient as provided, for example in FIG. 3.

In situation D, the feedback provider does not have the application and may be in a non-participating location. In this situation the feedback provider may go to the 45 sec.com, Apple apps, or Android website and could quickly download the application. In an aspect of the present disclosure, the application may download in under 60 seconds.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A system for soliciting and delivering consumer feedback from a feedback provider to a feedback recipient, the system comprising one or more feedback devices, one or more feedback applications, one or more automatic linkage devices, and one or more management modules, wherein
at least one feedback device comprises one or more processors, one or more memories, one or more user input interfaces capable of capturing input from a feedback provider, and one or more communication ports capable of transmitting and receiving data;
at least one feedback application is stored within one of said memories and is configured to run on one of said processors, and is further configured to use said input to create a feedback message for transmission to at least one automatic linkage device via said one or more communications ports;
at least one automatic linkage device comprising at least one communications port, wherein said automatic linkage device is configured to receive the feedback message and integrate one or more internal or external data sources to identify a communications link to a feedback recipient, and
at least one of said management modules is capable of delivering said digital data, or a part thereof, to said feedback recipient.

2. The system of claim 1, wherein said data is selected from the group consisting of a voice memo, a text, an image, a video, and any combinations thereof.

3. A method, comprising:
determining, by a mobile computing device, a current location of the mobile computing device;
identifying, by the mobile computing device, a feedback recipient based on the current location;
searching an event database to identify an event based on temporal and location information;
receiving user feedback for the feedback recipient at the mobile computing device; and
submitting, by the mobile computing device, the user feedback to the feedback recipient.

4. The method of claim 3, further comprising:
prompting a user of the mobile computing device that the feedback recipient would like feedback when the mobile computing device enters the current location,
wherein the prompt includes a quick response (QR) code and a solicitation message.

5. The method of claim 3, further comprising:
determining whether the feedback recipient is a participating business; and
automatically selects the feedback recipient when the feedback recipient is a participating business.

6. The method of claim 3, wherein user feedback includes data selected from the group consisting of a voice memo, a text, an image, a video, and any combinations thereof.

7. The method of claim 3, further comprising displaying a response received from the feedback recipient.

8. The method of claim 3, further comprising:
receiving a scanned product code, and
receiving user feedback for a product corresponding to the scanned product code, wherein the scanned product code is selected from the group consisting of UPC, ISBN and EAN.

9. The method of claim 3, wherein the determined current location includes a sub-location that pinpoint a subdivision inside a feedback recipient's business promise and provide tunable granularity.

10. The method of claim 9, wherein the sub-location, depending on the feedback recipient, is one of a room in a hotel, a department within a store, an exhibit hall within a museum, a specific location of a restaurant.

11. The method of claim 3, further comprising:
receiving an email from the feedback recipient that contains a coupon or refund voucher.
